(19) United States
(12) Patent Application Publication
(10) Pub. No.: US 2008/0189937 A1
(43) Pub. Date: Aug. 14, 2008

(54) Method of making a connector with an injection-molding technique

(75) Inventor: Kuang-Hua Shiu, Jhongli City (TW)

Correspondence Address: Troxell Law Office Pllc, Suite 1404, 5205 Leesburg Pike, Falls Church, VA, 22041, US

(73) Assignee: Singatron Enterprise Co., Ltd.

(21) Appl. No.: 11/703,833

(22) Filed: Feb. 8, 2007

(51) Int. Cl. H01R 13/405; B29C 33/40

(52) U.S. Cl. 29/747; 439/736; 264/219

(57) ABSTRACT

A method of making a connector by an injection-molding technique is provided, wherein terminals are molded by casting, raw material to be poured in is zinc alloy, and raw material of which is provided with low cost and high hardness, such that manufacturing cost can be saved, and the hardness of terminals can be increased, without easily causing the terminals to be bended, cracked, and fractured, upon being subjected to external force. Moreover, production capacity of the terminals can be increased by this technique of manufacturing process to mold the terminals.

### BACKGROUND OF THE INVENTION

(a) Field of the Invention

The present invention relates to a method of making a connector with an injection-molding technique, and more particularly to a manufacturing method wherein a terminal is made by a casting technique and raw material used for making the terminal is zinc alloy.

(b) Description of the Prior Art

A conventional terminal is made by a brass rod which is formed by a lathing technique. However, as production capacity of the terminal is too slow, and material of the brass rod is provided with lower hardness and higher cost, the terminal will be bended, cracked, and fractured if it is subjected to external force.

### SUMMARY OF THE INVENTION

The primary object of present invention is to provide a method of making a connector with an injection-molding technique, wherein a terminal is manufactured by a casting technique, raw material of the terminal is zinc alloy, and raw material of the zinc alloy is provided with low cost and high hardness, such that manufacturing cost can be saved and hardness of the terminal can be increased, without easily resulting in that the terminal is bended, cracked, and fractured, upon being subjected to external force.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a system block diagram of the present invention.

FIG. 2 shows a first schematic view of an embodiment of the present invention.

FIG. 3 shows a second schematic view of an embodiment of the present invention.

FIG. 4 shows a third schematic view of an embodiment of the present invention.

FIG. 5 shows a fourth schematic view of an embodiment of the present invention.

FIG. 6 shows a fifth schematic view of an embodiment of the present invention.

FIG. 7 shows a sixth schematic view of an embodiment of the present invention.

FIG. 8 shows a seventh schematic view of an embodiment of the present invention.

FIG. 9 shows an eighth schematic view of an embodiment of the present invention.

### DETAILED DESCRIPTION OF THE PREFERRED EMBODIMENTS

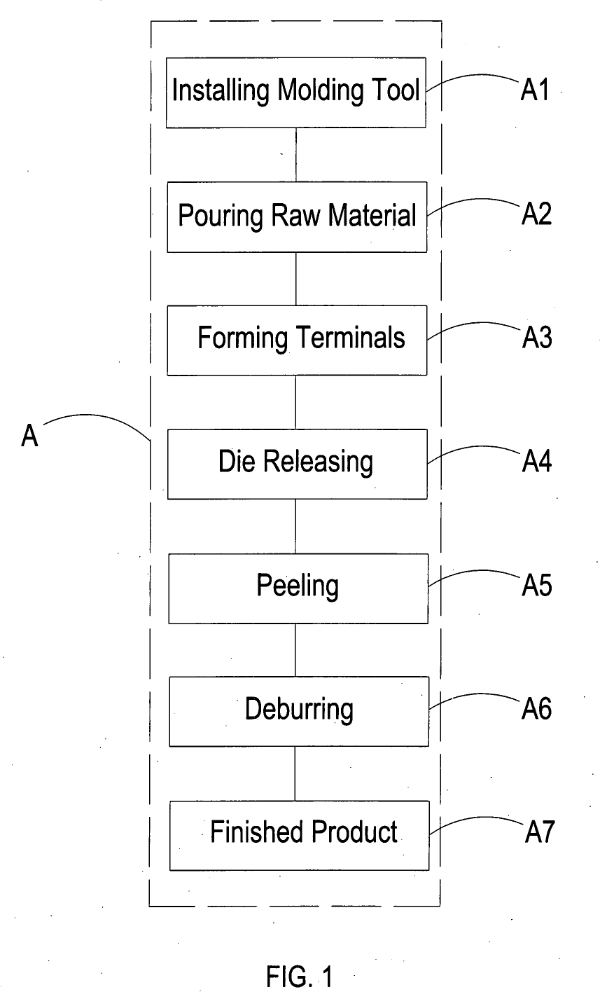

Referring to FIG. 1, the present invention is to provide a method of making a connector with an injection-molding technique, wherein a manufacturing process of a terminal A includes an installation of a molding tool A1 by which a casting template is fixed on a platform; pouring raw material A2 into the casting template to form the terminal A3, resulting in a semi-finished product after forming the terminal A3; carrying out a mold releasing to the semi-finished product on the casting template A4; peeling the terminal after performing the mold releasing A5; carrying out a deburring through a grinding mill A6, after peeling the terminal A5, as side edges of the semi-finished product are provided with the burrs; and finally, forming a finished product A7 after deburring A6. Moreover, in the step of pouring the raw material A2, the raw material to be poured in is zinc alloy, and raw material of the zinc alloy is provided with low cost and high hardness, such that its manufacturing cost can be saved, and the hardness of terminal can be increased, without easily resulting in that the terminal is bended, cracked, and fractured, upon being subjected to external force.

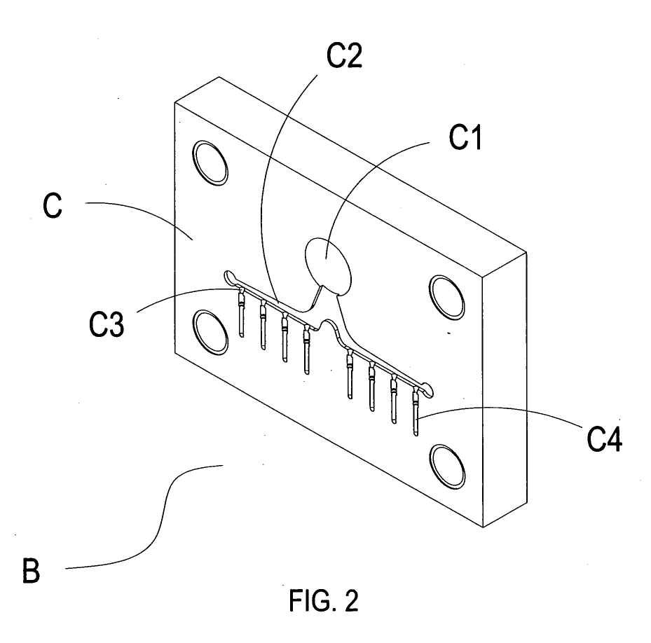

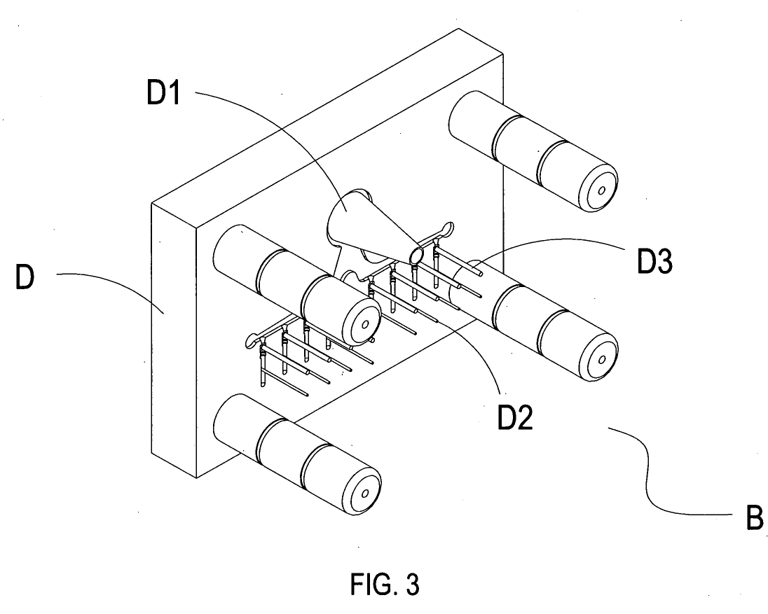

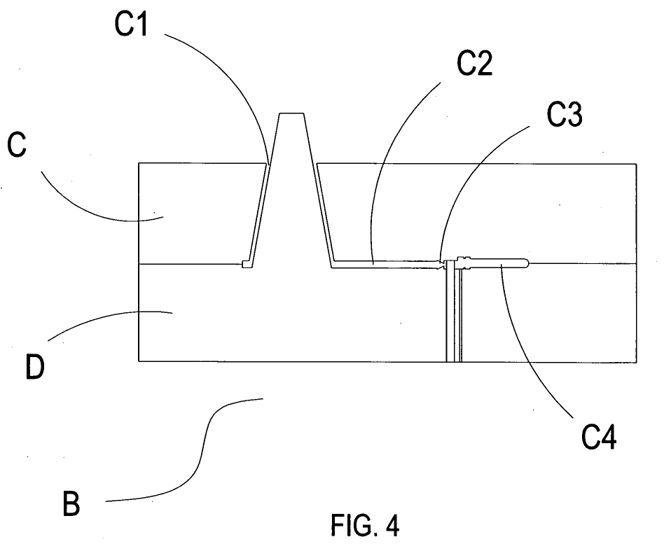

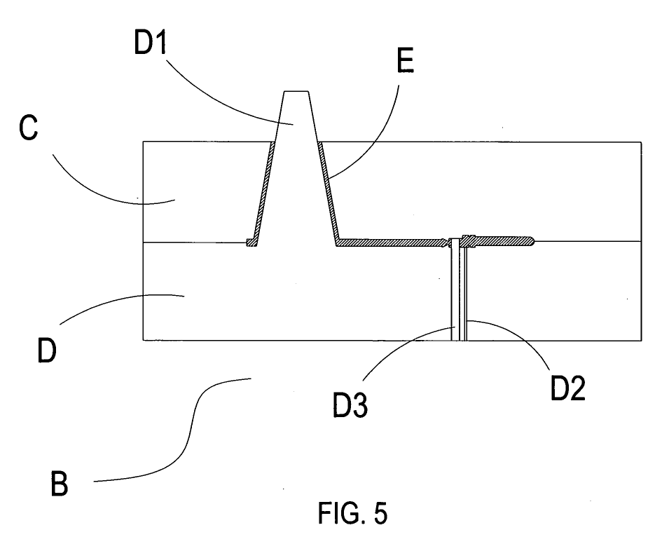

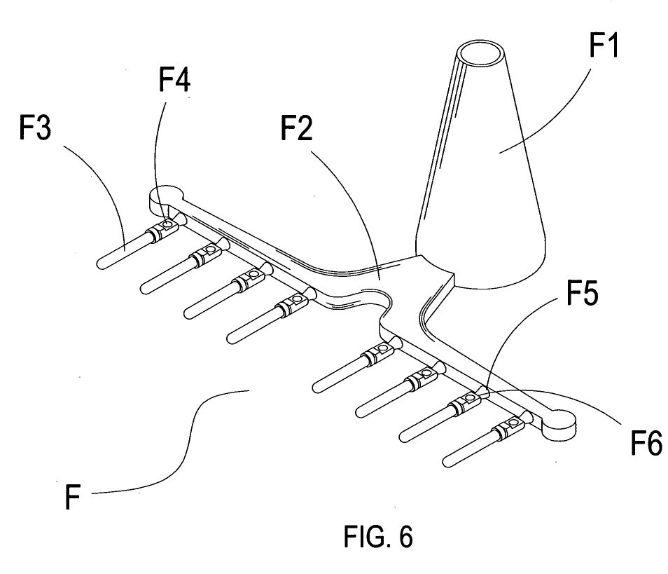

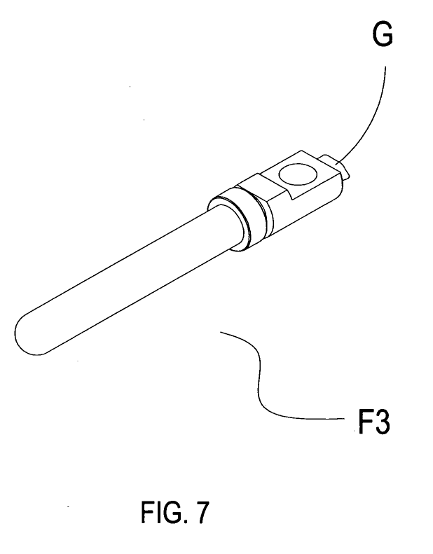

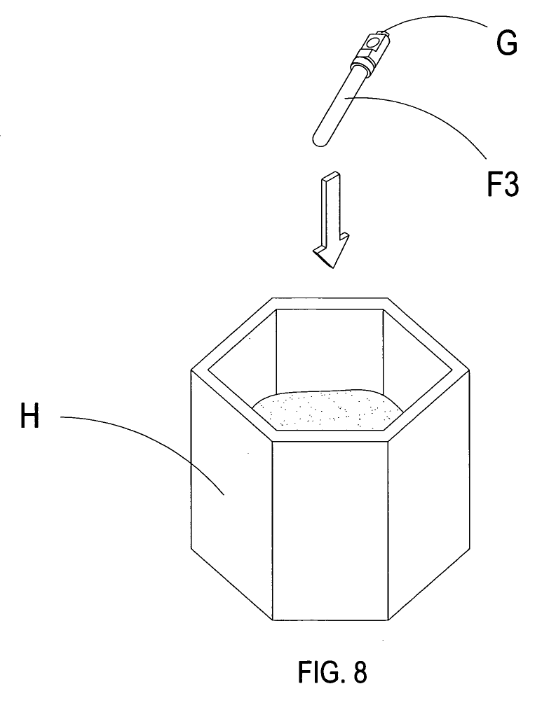

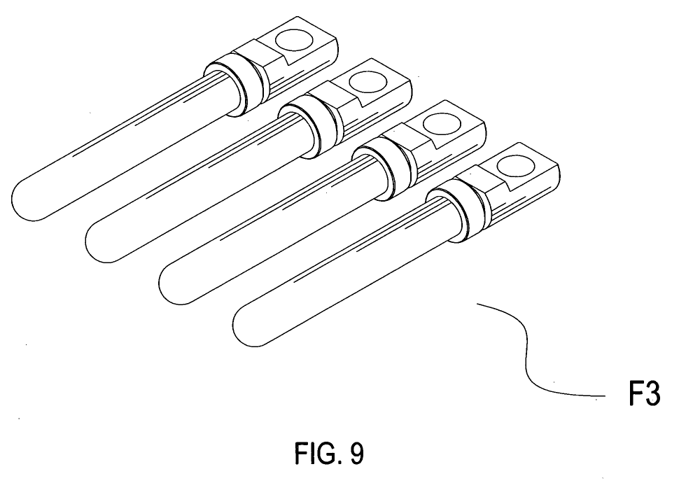

Referring to FIGS. 2 to 9, upon implementing a method of making a connector by an injection-molding technique of the present invention, a male die D and a female die C are tightly assembled by a casting template B first, and then raw material E is poured into through a pouring hole C1 of the female die C, such that the raw material E can be poured into and spreading to a pouring channel C2, followed by flowing into a plurality of branch channels C3 and pouring into molding zones C4 correspondingly, thereby enabling the terminals F3 to be formed in the molding zones C4.

When the terminals F3 are formed in the molding zones C4 and need to be released from dieing, the male die D will be separated with the female die C, and in a same time, a semi-finished product F will be pushed until falling out by push-out pins D2 of the male die D, such that the semi-finished product F can be easily escaped from a guiding rod D1 of the male die D by the push-out pins D2, and a deformation and a die adhesion will not easily result to the terminals F3 upon molding.

The semi-finished product F is integrally formed by a cylinder F1, a seat F2, and the terminals F3, wherein the cylinder F1 is formed by a mutual corresponding of the guiding rod D1 of the male die D with the pouring hole C1 of the female die C, the seat F2 is formed by the pouring channel C2 and the branch channels C3 of the casting template B, and the terminals F3 are formed by carrying out an injection-molding in the molding zones C4, whereas holes F4 of the terminals F3 are formed by pins D3 of the male die D.

If the terminals F3 are to be escaped from the seat F2, as long as first connection surfaces F5 of the seat F2 are peeled from second connection surfaces F6 of the terminals F3, then the terminals F3 will be separated with the seat F2. After separating the terminals F3 with the seat F2, the second connection surfaces F6 of the terminals F3 will have irregular burrs G which can be removed by a grinding mill H, such that the terminals F3 can be completely cleared with the burrs G.

In order to further manifest the advancement and the practicability of the present invention, the advantages thereof are listed below:
1. A plurality of terminals can be manufactured at a same time by casting the terminals.
2. According to item 1, time of manufacturing can be saved, and more terminals can be made.
3. Raw material used for making the terminals is zinc alloy.
4. According to item 3, the raw material is provided with low cost and high hardness.
5. According to item 4, the terminals will not be bended, cracked, and fractured from an impact to the terminals.
6. It is provided with industrial competitiveness.
7. It is provided with value of business utilization.
8. It is provided with novelty.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A method of making a connector by an injection-molding technique, wherein terminals are formed by first installing a molding tool, pouring raw material, and being formed with a casting technique into a semi-finished product, followed by performing a mold releasing to the semi-finished product and then peeling, finally by deburring with a grinding mill to form into a finished product, with a technique of manufacturing process for molding the terminals being used to increase production capacity of the terminals; the raw material to be poured in being raw material of zinc alloy, and the raw material of zinc alloy being provided with low cost and high hardness, thereby saving manufacturing cost and increasing the hardness of terminals, without easily causing that the terminals are bended, cracked, and fractured, upon being subjected to external force.

2. The method of making a connector by an injection-molding technique, according to claim 1, wherein the terminals which are molded by casting are made by tightly assembling a male die with a female die, and then by pouring the raw material.

3. The method of making a connector by an injection-molding technique, according to claim 1, wherein when the terminals need to be released from dieing after being formed, the semi-finished product is pushed until falling out by push-out pins of the male die.
